(19) United States
(12) Patent Application Publication
(10) Pub. No.: US 2010/0010671 A1
(43) Pub. Date: Jan. 14, 2010

(54) INFORMATION PROCESSING SYSTEM, INFORMATION PROCESSING METHOD, ROBOT CONTROL SYSTEM, ROBOT CONTROL METHOD, AND COMPUTER PROGRAM

(76) Inventor: Atsushi MIYAMOTO, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/497,802

(22) Filed: Jul. 6, 2009

(30) Foreign Application Priority Data
Jul. 14, 2008 (JP) P2008-182132

(51) Int. Cl. G06F 15/16; G06F 9/46

(52) U.S. Cl. 700/247; 709/206; 719/314

(57) ABSTRACT

An information processing system includes a synchronous processing unit configured to execute a group of modules to perform synchronous real-time processing in a single process serving as a unit of execution of a program, a parallel processing unit configured to arrange modules which allow asynchronous processing and which should perform parallel processing in different processes and execute the modules in parallel, and an intermodule communication unit configured to perform transmission and reception of data among the modules by means of message passing.

### BACKGROUND OF THE INVENTION

1. Field of the Invention

The present invention relates to information processing systems which perform distributed processing in terms of modularization, parallelization, and reusability, information processing methods, robot control systems, robot control methods, and computer programs. The present invention, for example, relates to information processing systems applicable to control of robots which perform interaction with persons or environment, information processing methods, robot control systems, robot control methods, and computer programs.

Specifically, the present invention relates to an information processing system applicable to control of a robot including control of physical motions (hereinafter referred to as “motion control”), such as motions of joints, and control other than the motion control, an information processing method, a robot control system, a robot control method, and a computer program. More particularly, the present invention relates to an information processing system which attains synchronous real-time performance for the motion control and parallelization of processes for control which is other than motion control and which allows asynchronous performance, an information processing method, a robot control system, a robot control method, and a computer program.

2. Description of the Related Art

Research and development of robots has been carried out for various purposes or usages so that robots perform human works as alternatives of human beings, for example. In recent years, there has been a strong demand for realization of various physical interactions with human beings or environment so that robots mentally assist people. For example, a robot which chooses a motion by comprehensively judging a result of recognition of external environment through sight and hearing and an internal state, such as instinct and emotion, has been proposed (refer to Japanese Patent No. 3558222, for example).

The inventors deem that a distributed system is suitable for a robot control system for some reasons.

As a first reason, a robot, utilizes various sensor devices. Different sensor devices have different cycles of obtainments of information, and the different sensor devices generate interruptions of control software at different timings. If control is stopped every time the interruption occurs, it is possible that control performance is adversely affected. In order to effectively process such an interruption, it is preferable that process routines are provided for individual sensor devices and performed in an asynchronous manner. That is, the distributed system which operates in an asynchronous manner is deemed suitable for a robot control system.

As another important reason, processes are modularized, and in accordance with the modularization, improvement of parallelization and reusability of the processes are realized. This is possible by dividing control of a robot into a plurality of processes having high dependencies, such as motion control, visual recognition, sound recognition, and a motion plan, and the individual processes are easily modularized. Since high calculation costs may be necessary depending on the process, there is a strong demand for parallel execution of the modules. For example, a robot-motion control system including different motion modules which execute different tasks and which may be executed in parallel has been proposed (refer to Japanese Patent No. 3558222). In the proposed robot-motion control system, an execution right is selectively assigned to the motion modules in accordance with priority levels thereof, and it is possible to restart the tasks.

Furthermore, in general software, there is a demand for reuse of a process module, which has once implemented, in another robot.

As described above, in terms of modularization, parallelization, and reusability, a distributed system is positively used for control of a robot.

A control system of a robot may be divided into motion control which controls physical motions such as motions of joints and control other than the motion control.

The motion control is performed to attain operations suitable for external environment which momentarily changes. Therefore, various sensor information items including information on sight, information on sense of touch, information of posture, and information on an angle of a joint should be immediately fed back so that a control value is supplied taking the information items into consideration. In recent years, various sophisticated methods for motion control including position control, power control, hybrid control, and impedance control have been proposed. However, in order to stably operate these complicated control operations, the control operations should be performed in millisecond-order cycles. If the control operations are not performed in accordance with the control cycles for some reason, a robot does not perform desirable operations. Accordingly, fatal errors occur, that is, the robot tumbles or the robot harms environment, for example. Therefore, the motion control for a robot is preferably realized by a control system which attains synchronous real-time performance.

In addition, since the motion control has become complicated in recent years, the distributed system is preferably employed. In order to complete the operations in various situations, a plurality of control methods, such as object-gripping control, walking control, tumbling control, and external-force adaptation control, are provided, and the control methods are freely switched from one to another or some of the control methods are combined with one another while a situation is judged. In order to describe content of such a complicated control operation, the control operations are implemented as individual modules for individual control operations. That is, content of the motion control is also preferable to be constituted as a distributed system. Note that the motion control should be operated in millisecond-order control cycles and should be a distributed, system which satisfies a requirement of a real-time system.

On the other hand, in general control other than the motion control, various processes including object recognition using visual information, motion recognition, estimation of a motion of an environmental object using sense of touch, sound recognition, and calculation for a machine intellectual faculty using results of the recognitions should be performed. Although each of the processes may fake approximately several hundred milliseconds to several seconds for a calculation, since real-time performance which is normally necessary for the motion control is not necessary, these processes may be performed in parallel using different computers (or processors). Furthermore, the recognition processes using visual sense, sense of touch, and sound have low interdependency, and are often individually executed in an asynchronous manner. That is, the control other than the motion control is suitable for the distributed system in which processes are executed in parallel in an asynchronous manner.

Specifically, the distributed system is suitable for the robot control system, and the distributed system includes two system requirements including a requirement of a distributed system which attains, as with the motion control, synchronous real-time performance and a distributed system in which processes are executed in parallel in an asynchronous manner in the control other than the motion control.

Here, examples of a general distributed system and examples of a real-time system will be described.

Architectures of distributed systems each of which includes a plurality of processors are roughly categorized into a tight-coupling architecture and a loose-coupling architecture. In the tight-coupling architecture, interprocess communication may be performed using a shared memory whereas in the loose-coupling architecture, message-exchange, i.e., message passing is mainly utilized. Although programming is easily performed in the tight-coupling architecture using the shared memory, the loose-coupling architecture has an advantage in that hardware is easily realized and excellent scalability is attained. An MPI (Message-Passing Interface) is a representative library for the message passing, and various functions (interfaces) are provided for various requests. The MPI is a standard used for communication using the message passing between computers which are distributed-memory parallel computers (processors) connected to one another in parallel (in other words, the functions are not directly called.) In order to perform the message passing between computers, each of the computers should include a message queue. Use of the message queue leads to asynchronous communication between the computers. That is, use of the MPI leads to asynchronous communication between computers, and therefore, it is difficult to employ the MPI for applications which employ a millisecond-order real-time system.

A representative example of an architecture which realizes the distributed object technique includes CORBA (Common Object Request Broker Architecture) which is used to simultaneously operate a plurality of computers connected to one another through a network. In the CORBA, general calls of object functions are synchronously processed. Every time an object function is called, serialization and network communication are performed due to an architecture configuration, and one call normally takes several milliseconds or more. (When communication beyond languages is performed between computers connected to each other through a network, a transmission source performs serialization to obtain redundant data). Therefore, it is difficult to employ the CORBA in applications which should be performed in millisecond-order real-time systems. Furthermore, when asynchronous processing is utilized, since it is not necessarily the case that processes which should be performed in a system are completed within a specific period of time, it is apparent that a requirement of the real-time system is not satisfied. Note that Conversion from an initial state (first state) into another state (second state) is referred to as serialization, and inversed conversion from the second state into the first state is referred to as deserialization. Specifically, in the serialization, a variable (field) representing a state of an object and an identifier representing a type (class) of the object are written in s form of a byte sequence or written in an XML format. On the contrary, in the deserialization, the serialized data is restored.

An example of a system which satisfies a function requirement of the real-time system includes an RTOS (Real Time Operating System) such as VxWorks and ONX. When the RTOS is used, applications may be performed in the real-time system. However, the RTOS does not have a system for parallel execution of real-time processing and asynchronous processing which takes several hundreds milliseconds to several seconds. In order to realize the parallel processing, processes should foe executed in parallel in a plurality of computers. However, the RTOS is specialized for the real-time system, and is designed assuming that, processes are performed in a single computer. In order to realize parallel execution in communication among computers, a communication standard for the computers should be defined or utilized. Therefore, when the real-time processing and the asynchronous processing using different computers are to be simultaneously realized, implementation becomes complicated.

As described above, when taking entire control of a robot, a distributed system should be employed for a configuration. Furthermore, research and development of a technique of the distributed system has been performed in the field of information processing.

For example, a distributed system applicable to control of robot arms is proposed in Japanese Unexamined Patent Application Publication No. 2002-342300.

However, a distributed system configured as a single system which attains two demands, that is, a demand for performing parallel processing of visual recognition and sound recognition, for example, using a plurality of computers (processors) irrespective of whether real-time performance is to be performed even in an asynchronous manner and a demand for performing real-time processing, as with motion control, in a synchronous manner, has practically not been proposed.

### SUMMARY OF THE INVENTION

It is desirable to provide an excellent information processing system, an excellent information processing method, an excellent robot control system, an excellent method for controlling a robot, and an excellent computer program which are suitably applicable to control of a robot which performs interaction with persons or environment.

It is further desirable to provide an excellent information processing system, an excellent information processing method, an excellent robot control system, an excellent method for controlling a robot, and an excellent computer program which are suitably applicable to control of a robot which perform motion control for controlling physical motions such as motions of joints and control other than the motion control.

It is further desirable to provide an excellent information processing system, an excellent information processing method, an excellent robot control system, an excellent method for controlling a robot, and an excellent computer program which realize synchronous real-time performance used for the motion control and parallel processing used for the control which, is other than the motion control and which allows asynchronous processing.

According to a first embodiment of the present invention, there is provided an information processing system including synchronous processing means for executing a group of modules to perform synchronous real-time processing in a single process serving as a unit of execution of a program, parallel processing means for arranging modules which allow asynchronous processing and which should perform parallel processing in different processes and executing the modules in parallel; and intermodule communication means for performing transmission and reception of data among the modules by means of message passing.

Note that the term “system” corresponds to a system including a plurality of apparatuses (or functional modules which realize specific functions) which are logically integrated, and it does not really matter whether the apparatuses (or the functional modules) are included in a single case.

For example, when entire control of a robot is taken into consideration, a distributed system is suitable in terms of modularization, parallelization, and reusability. The robot control includes two control operations, i.e., motion control in which modules should perform synchronous real-time processing and control which is other then motion control, which allows asynchronous processing, such as visual recognition and sound recognition, and in which modules should perform parallel processing. However, a distributed system configured as a single system which attains the synchronous real-time processing and asynchronous parallel processing has practically not been proposed,

Assuming that a unit of execution of a program in a computer is referred to as a “process”, message passing operations performed between processes to be processed in parallel are asynchronously performed (as described above). The same holds for a case where the processes are executed in an identical computer or different computers. On the other hand, message passing performed in a single process ensures real-time performance since serialization and deserialization may be omitted.

The robot control system is preferably configured as a distributed system which performs intermodule communication using message passing. In this invention, a plurality of modules to perform real-time processing are arranged in an identical process, and different processes have respective message brokers using when messages are exchanged among the modules.

Each of the message brokers determines whether serialization and deserialization are to be performed on message data and whether the message data should be temporarily stored in a message queue when message passing is performed between modules. Therefore, when message passing is performed in a single process, serialization and deserialization are omitted, and accordingly, high-speed message passing is achieved. Message Passing performed between processes is performed as distributed-memory parallel processing. However, since the message passing in a single process is performed as shared-memory parallel processing, the serialization and the deserialization of message data may be omitted.

The modules have respective message queues each of which temporarily stores a message transmitted, from another module. A determination as to whether the received message is to be stored in the message queue is appropriately made depending on a process including a message transmission-source module. Specifically, when a transmission-source module and a transmission-destination module are not included in an identical process, the transmission-destination module may temporarily store a received, message in the message queue, and execution of the transmission-source module and execution of the transmission-destination module may be separately performed, that is, asynchronous distributed processing is realized. On the other hand, when the transmission-source module and the transmission-destination module are included in an identical process, the transmission-destination source may omit the processing for storing the received message in the message queue. Accordingly, message passing may be performed with a processing load the same as that of a function call, and synchronous processing of messages among modules in a single process is realized.

Each of the modules includes a function for obtaining a list of transmission messages and a function for obtaining a list, of reception messages included in each of the modules, and may collect message transmission/reception information regarding transmission modules and reception modules of messages in accordance with the function for obtaining a list of transmission messages and the function for obtaining a list of reception messages included in each of the modules. Furthermore, the system may include a configuration file which includes computer names which execute processes, module names included in the processes, and message processing timings for the modules and which specifies a message having the process-order dependency. The process-order-dependency relationship may be obtained using the configuration file and the message transmission/reception information. Each of the message brokers may appropriately process messages using the function for obtaining the list of transmission messages and the function for obtaining the list of reception messages. When a module on a reception side receives a message, each of the message brokers may determine whether the received message is to be stored in a message queue of the reception module in accordance with a message processing timing of the reception module described in the configuration file.

The information processing system may include two or more computers (processors). Parallel processing is ensured among different computers (processors). Accordingly, among modules which are to be asynchronously executed by the parallel processing means, especially modules to be executed in parallel may be distributed in different processes to be executed in different computers. In this way, the parallel processing is reliably realized.

Accordingly, with this configuration, a distributed system which satisfies requirements of the asynchronous parallel processing and the synchronous real-time processing may be configured in a single platform.

When processing is periodically performed such as a periodical processing of motion control of a robot, normally, interruption processing is utilized. For example, when sensor devices disposed in various portions of the robot obtain information items, interruption occurs in control software. When a motion control program is implemented so that, a series of periodical processes are divided into a plurality of modules and the modules cooperatively operate with one another, interruptions may be generated in the individual modules. However, in this case, a problem of process-order dependency occurs among the modules. For example, it is assumed that control of angles of joints of a hand and control for gripping an object using a hand are implemented as individual control modules, i.e., a joint-angle control module and an object-gripping control module. In this case, when a joint-angle instruction is first issued in response to an interruption which occurred in the joint-angle control module, a joint-angle instruction issued for the object-gripping control is not reflected in this control cycle.

To address this problem, the robot control system is configured as a distributed system which performs intermodule communication using the message passing (as described above). In this robot control system, the process-order dependency among the modules is determined in accordance with the message transmission/reception relationships among the modules.

For example, the joint-angle control and the object-gripping control are implemented as individual control modules and are included in a single process. In this case, the synchronous processing of messages is realized among the modules. Furthermore, the joint-angle instruction for the object-gripping control is transmitted to the joint-angle control module by message passing. The process-order dependency between the joint-angle control module and she object-gripping control module may be determined in accordance with the message transmission/reception relationship between these modules. Specifically, in the message transmission/reception relationships among modules serving as transmission-destination modules in synchronous multicast transmission, a root module serving as a transmission source is extracted first, and the process-order-dependency is obtained in accordance with an order of connection of the modules starting from the root module,

Accordingly, in the robot control system, for a group of modules having a problem of the process-order dependency, interruptions may be automatically generated (that is, without determination of a person (an operator, for example)) in the modules in an appropriate order using an algorithm in which an order of interruption is determined in accordance with the message transmission/reception relationships.

According to a second embodiment of the present invention, there is provided a computer-readable program which includes a plurality of modules and which is to be executed in a computer, the computer program makes the computer function as synchronous processing means for executing a group of modules which should be subjected to synchronous real-time processing in a single process serving as a unit of execution of a program, parallel processing means for arranging modules which allow asynchronous processing and which should be subjected to parallel processing in different processes and executing the modules in parallel, and intermodule communication means for performing transmission and reception of data among the modules by means of message passing.

The computer-readable program of this embodiment realizes predetermined processing in the computer. That is, by installing the computer program of this embodiment in the computer, cooperative operation is realized in the computer, and accordingly, an advantage the same as that of the information processing system of the first embodiment is attained.

Accordingly, the present invention provides an excellent information processing system, an excellent information processing method, an excellent robot control system, an excellent method for controlling a robot, and an excellent computer program which are suitably applicable to control of a robot which performs interaction with persons or environment.

Furthermore, the present invention provides an excellent, information processing system, an excellent information processing method, an excellent robot control system, an excellent method for controlling a robot, and an excellent computer program which are suitably applicable to control of a robot which perform motion control for controlling physical motions such as motions of joints and control other than the motion control.

Moreover, the present invention provides an excellent information processing system, an excellent information processing method, an excellent robot control system, an excellent, method for controlling a robot, and an excellent, computer program which realize synchronous real-time performance used for the motion control and parallel processing used for the control which is other than the motion control and which allows asynchronous processing.

Accordingly, even a function which is to be performed as a real-time system, such as motion control, may be divided into modules, and furthermore, functions, such as object recognition and intelligent mechanism, are modularized as modules so that parallel distributed processing is realized. Consequently, ail the modules are connected to one another in a seamless manner, and accordingly, a system configuration having consistency of an entire application is realized. Although a robot which perform interaction with persons and environment generally have a complicated functional configuration, when the present invention is applied to such a robot, the advantages described above are attained.

Furthermore, in synchronous multicast message communication, a problem of process-order dependency is automatically solved. When the motion control is divided into a plurality of modules, process-order dependency may be generated among the modules. However, the control system appropriately operates by solving a problem of the process-order dependency.

Further features and advantages of the present invention will become apparent from the following description of embodiments with reference to the attached drawings.

### BRIEF DESCRIPTION OF THE DRAWINGS

FIG. 1 is a diagram schematically illustrating a functional configuration of a robot apparatus according to an embodiment of the present invention;

FIG. 2 is a diagram illustrating a configuration of a controller shown in FIG. 1 in detail;

FIG. 3 is a diagram illustrating a system for performing intermodule communication using message passing in a distributed system;

FIG. 4A is a diagram illustrating an example of a configuration of a distributed system;

FIG. 4B is a diagram illustrating a state in which message brokers are provided for individual processes in the distributed system shown in FIG. 4A;

FIG. 5 is a flowchart illustrating a procedure of processing executed by each of the message brokers when a message is supplied;

FIG. 6 is a flowchart illustrating a procedure of processing of message passing when a message queue is used;

FIG. 7 is a flowchart illustrating a procedure of processing of message passing when a message queue is not used;

FIG. 8 is a diagram illustrating a state in which synchronous multicast transmission is performed on a plurality of modules in a certain process of the distributed system;

FIG. 9 is a diagram illustrating a state in which synchronous multicast transmission is performed in a certain process using a message broker;

FIG. 10 is a diagram illustrating determination of the relationship among modules using the message passing;

FIG. 11 is a diagram illustrating an example of an algorism for automatically deriving the process-order dependency relationship among modules in a certain process in accordance with the message transmission/reception relationship among the modules, and specifically illustrating the message transmission/reception relationship in the process;

FIG. 12 is a diagram illustrating an example of an algorism for automatically deriving the process-order dependency relationship among modules in a certain process in accordance with the message transmission/reception relationship among the modules, and specifically illustrating the message transmission/reception relationship among the modules in the process;

FIG. 13 is a flowchart illustrating a procedure of processing for automatically deriving the process-order dependency relationship among the modules in the certain process in accordance with the message transmission/reception relationship among the modules;

FIG. 14 is a diagram illustrating a subsystem relating to visual control in a motion control system of a robot;

FIG. 15 is a flowchart illustrating a procedure of activation processing of the distributed system;

FIG. 16 is a diagram illustrating text description representing a configuration of a system configuration file corresponding to an example of a configuration of the distributed system shown in FIG. 14;

FIG. 17 is a diagram illustrating pseudo code of a module which is a component of the distributed system according to the embodiment of the present invention;

FIG. 18 is a diagram illustrating a sequence in which message passing is performed from a module “Vision Data Acquisition” to a module “Visual Perception” in a first process executed in a first computer through a message broker in the first process;

FIG. 19 is a diagram illustrating a sequence in which interprocess message passing is performed from the module “Visual Perception” in the first process executed in the first, computer to a module “Visual Attention” in a second process executed in a second computer through message brokers in the first and second processes; and

FIG. 20 is a diagram illustrating a sequence in which message passing (synchronous multicast transmission) is performed from a module “Control Trigger” to a plurality of modules, i.e., a module “Vision Controller” and a module “Cartesian Controller” in a third process executed in the first computer through a message broker in the third process,

### DESCRIPTION OF THE PREFERRED EMBODIMENTS

Embodiments of the present invention will foe described in detail hereinafter with reference to the accompanying drawings.

### A. Robot Apparatus and Robot-Apparatus Control System

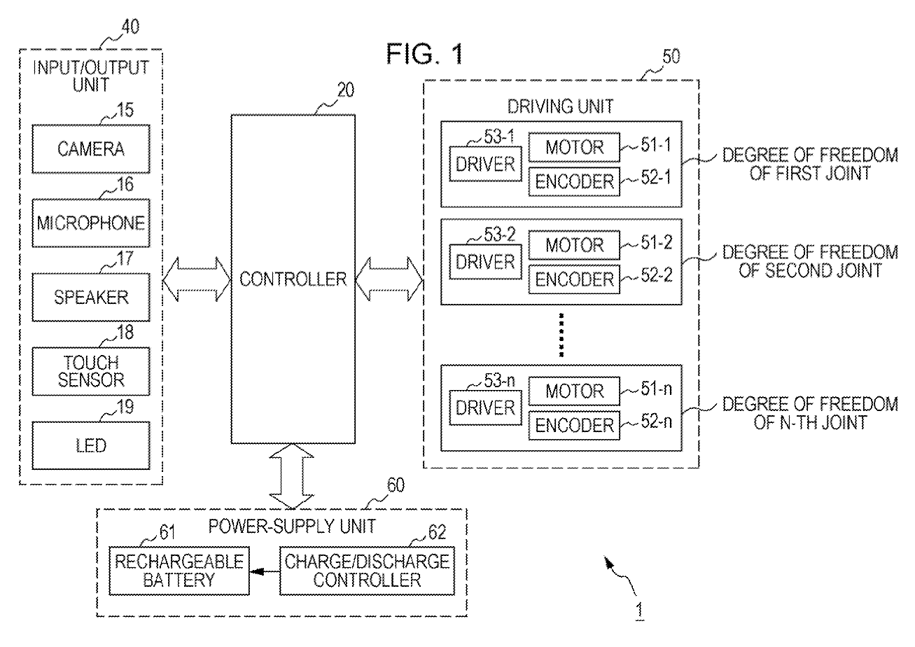

FIG. 1 is a diagram schematically illustrating an example of a configuration of a robot apparatus according to an embodiment of the present invention which realizes control using a distributed processing system. A robot apparatus 1 includes a controller 20 which performs integrated control of all operations of the robot apparatus and other data processing operations, an input/output unit 40, a driving unit 50, and a power-supply unit 60,

The input/output unit 40 includes, as input units, CCD cameras 15 corresponding to eyes of the robot apparatus 1, microphones 16 corresponding to ears, touch sensors 18 which sense the touch of a user and which are disposed on certain portions, such as a head and a back, and various sensors corresponding to the five senses. The input/output unit 40 further includes, as output units, a speaker 17 corresponding to a mouth and LED (Light Emitting Diode) indicators (eye lamps) 19 which are used to represent facial expressions by combinations of various types of blinking or by lighting timings. The output units also indicate user's feedbacks from the robot apparatus 1 in forms of sound and blinking of the lamps which are different from forms of mechanical motion patterns by legs, for example.

The driving unit 50 is a functional block which realizes mechanical operations of the robot apparatus 1 in accordance with predetermined motion patterns instructed by the controller 20, and is to be controlled when motion control is performed. The driving unit 50 includes a plurality of driving blocks disposed for individual axes such as roll axes, pitch axes, and yaw axes of joints, and realizes various degrees of freedom of the joints included in the robot apparatus 1. Each of the driving blocks includes a motor 51 which performs a rotating operation about a predetermined axis, an encoder 52 which detects a rotation position of the motor 51, and a driver 53 which adaptively controls the rotation position and a rotation speed of the motor 51 in accordance with & signal output from the encoder 52. The robot apparatus 1 may be configured as a two-legged mobile robot or a four-legged mobile robot in accordance with a combination of the driving blocks.

The power-supply unit 60 supplies power to various electric circuits in the robot apparatus 1. The robot apparatus 1 is autonomously driven using a battery, and the power-supply unit 60 includes a rechargeable battery 61 and a charge/discharge controller 62 which controls a charge/discharge state of the rechargeable battery 61.

The controller 20 corresponds to a brain and is disposed on a head unit or a body unit, for example, of the robot apparatus 1.

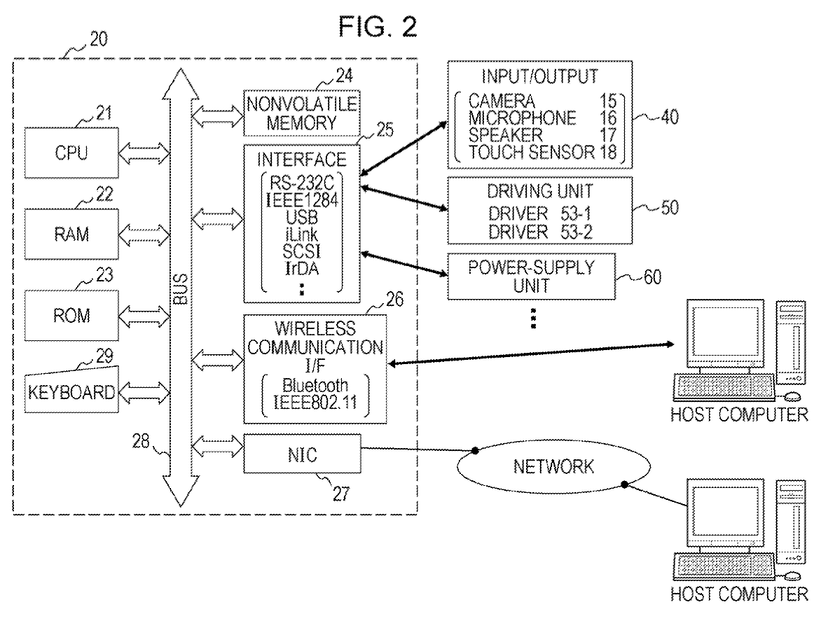

FIG. 2 is a diagram illustrating a configuration of the controller 20 shown in FIG. 1 in detail. As shown in FIG. 2, in the controller 20, a CPU (Central Processing Unit) 21 serving as a main controller is connected to memory units, circuit components, and peripherals by a bus 28.

A RAM (Random Access Memory) 22 is a writable memory including a nonvolatile memory, such as a DRAM (Dynamic RAM), and is used to load program code to be executed by the CPU 21 and temporarily store work data for execution programs. A ROM (Read Only Memory) 23 permanently stores control programs and data. Note that the control programs of the robot apparatus 1 include a “sensor input/recognition program” for processing signals input from the sensors, such as the CCD cameras 15 and the microphones 16, and recognizing the signals as symbols, a “motion control program” for controlling a storing operation (which will be described hereinafter), such as short-term memory and long-term memory, and controlling motions of the robot apparatus 1 in accordance with the signals input from the sensors and predetermined motion-control models, and a “driving control program” for controlling driving of joint motors and sound output from the speaker 17 in accordance with the motion control models.

A nonvolatile memory 24 corresponding to an electrically erasable-and-rewritable memory device, such as an EEPROM (Electrically Erasable and Programmable ROM), is used to store data to foe frequently updated in a nonvolatile manner. The data to be frequently updated includes information on an encryption key, other security information items, and device-controlling programs to be installed after shipping.

An interface 25 is connected to other devices outside of the controller 20, and enables data exchange. The interface 25 performs data input/output with the CCD cameras 15, the microphones 16, and the speaker 17, for example. Furthermore, the interface 25 receives data and commands from or transmits data and commands to drivers 53-1 to 53-n included in the driving unit 50.

The interface 25 may correspond to a general interface to be connected to peripherals of a computer, including a serial interface such as an RS-232C, a parallel interface such as an IEEE1284, a USB interface, an i-Link (IEEE1394) interface, an SCSI interface, and a memory-card interface (card slot) which receives a PC card or a memory stick so as to transmit programs and data to or receive programs and data from an external apparatus locally connected, thereto. Alternatively, the interface 25 may correspond to an infrared communication (IrDA) interface so as to communicate with an external apparatus in a wireless manner.

The controller 20 further includes a wireless communication interface 26 and a network interface card (NIC) 27 which are used to perform data communication with various external host computers through proximity wireless data communication such as Bluetooth (registered trademark) communication, a wireless LAN (Local Area Network) complying with IEEE802.11, or a wide area network, such as the Internet. Through the data communication between the robot apparatus 1 and a host computer, complicated operation control of the robot apparatus 1 is computed and the robot apparatus 1 is remotely controlled using remote computer resources.

The motion control system of the robot apparatus 1 is implemented using an object-oriented technique. Use of the object-oriented technique enables effective development and maintenance of software. Software developed using the object-oriented technique basically includes module units each of which is referred to as an “object” collectively including data and a method for processing the data. A plurality of objects are generated and combined with one another so that a single software application is generated.

Note that an object-oriented paradigm is realized by main basic techniques including “capsulation”, “class and instance”, “class inheritance”, and “message passing”. The term “capsulation” corresponds to a technique of integrating data and a method. The term “class” defines a plurality of objects integrally managed. The term “instance” corresponds to an entity of each of the objects which belong to a class. Note that since the objects, i.e., instances, which belong to an identical class, have basically identical methods, different methods are not defined for the individual objects. The term “inheritance” corresponds to a technique in which a definition of a certain class is inherited by another class (a lower class, for example), (Note that, when a class is to be newly defined, only a portion different from a class which has been defined is added.) The term “message passing” corresponds to a technique of transmission of messages to the individual objects so that performance of a predetermined operation is instructed. Since each of the objects hides data therein, access to the objects is not allowed using any other methods but the message passing method.

Furthermore, although described hereinafter, the motion control system of the robot apparatus 1 includes a plurality of modules implemented by the object-oriented technique (described above). Each of the modules implemented using the object-oriented technique is referred to as a “schema”. A tree-shaped hierarchy is formed by a plurality of schemas whereby the motion control system is configured.

### B. Configuration of Distributed System

As described in “Background of the Invention”, the robot control, includes motion control in which modules are synchronously processed in real time and control other than the motion control. The control other than the motion control allows asynchronous processing, such as visual recognition and sound recognition, while modules are processed in parallel. The motion control system according to this embodiment is configured as a distributed system in terms of modularization, parallelization, and reusability, and is especially configured as a single system which allows synchronous real-time processing and asynchronous parallel processing. In such a distributed system, message passing among modules which perform the synchronous real-time processing and process-order dependency among the modules which occurs in a case where synchronous multicast transmission is to be performed in a process when an interruption occurs, for example, are taken into consideration. Hereinafter, these points will be described in detail.

### B-1. Intermodule Communication Using Message Passing

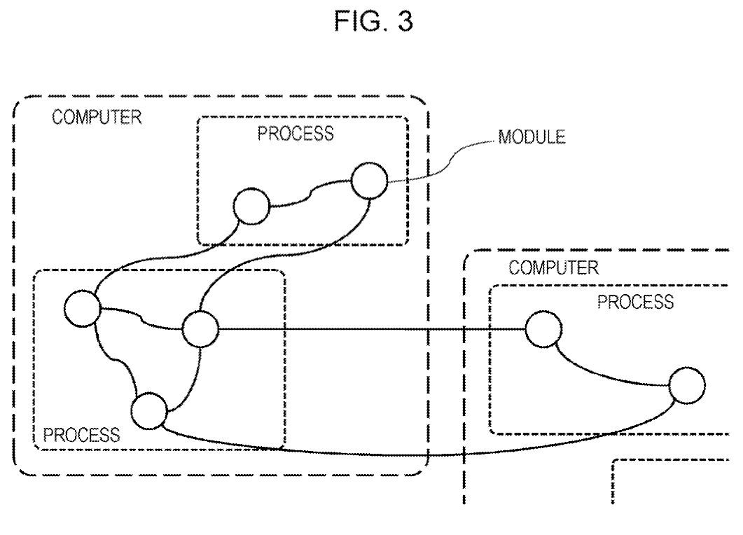

A system for performing intermodule communication using message passing will be described with reference to FIG. 3.

In FIG. 3, modules correspond to software objects implemented by the object-oriented technique (described above), and are units of instances generated. (The instances correspond to entities of objects which belong to a class.)

A process corresponds to a unit used to execute a program using a computer. In this embodiment, a single process may include a plurality of modules. Furthermore, as shown in FIG. 3, the plurality of modules may be arranged in a single process, in a plurality of processes, or in different processes in different computers.

Although the intermodule communication may be performed in a single process, in a plurality of processes, or in different processes in different computers, the modules are only accessed by a method employing message passing. Message passing is a technique of transmission of messages to the individual objects so that performance of predetermined operations is instructed.

Message passing includes unicast which is one-to-one communication between modules and multicast which is one-to-many communication among modules. Curve lines shown in FIG. 3 represent paths of the message passing (that is, message transmission/reception relationships among the modules).

Interprocess message passing is performed as parallel processing of a distributed memory type, and at boundaries of the processes, serialization and deserialization are performed on message data. On the other hand, the message passing performed in a single process corresponds to shared-memory parallel processing, and serialization and deserialization to be performed on the message data are omitted.

Each of the modules has a message queue which temporarily stores messages received from other modules. Normally, the messages stored in the message queue are extracted from the message queue at certain timings and are processed by the module of interest. The certain timing includes a timing when an execution right is assigned to the module of interest in accordance with scheduling of a processor and timings when interruption events periodically occur. Each of the modules may directly process a received message without storing it in the message queue.

In a case where the distributed system includes two or more computers (processors), in general, parallel processing is ensured among the different computers (processors). Among combinations of modules which allow asynchronous processing, combinations of modules which should be executed in parallel are reliably processed in parallel when the modules are distributed in the different computers (processors).

B-2. High-Speed Message Passing through Message Broker

In the distributed system according to this embodiment, when message passing is performed between modules in an identical process, processing time for serialization and deserialization is eliminated whereby high-speed communication is realized.

### B-2-1. Message Broker

The processes include respective message brokers each of which determines whether the serialization and the deserialization should be performed when the message passing is performed.

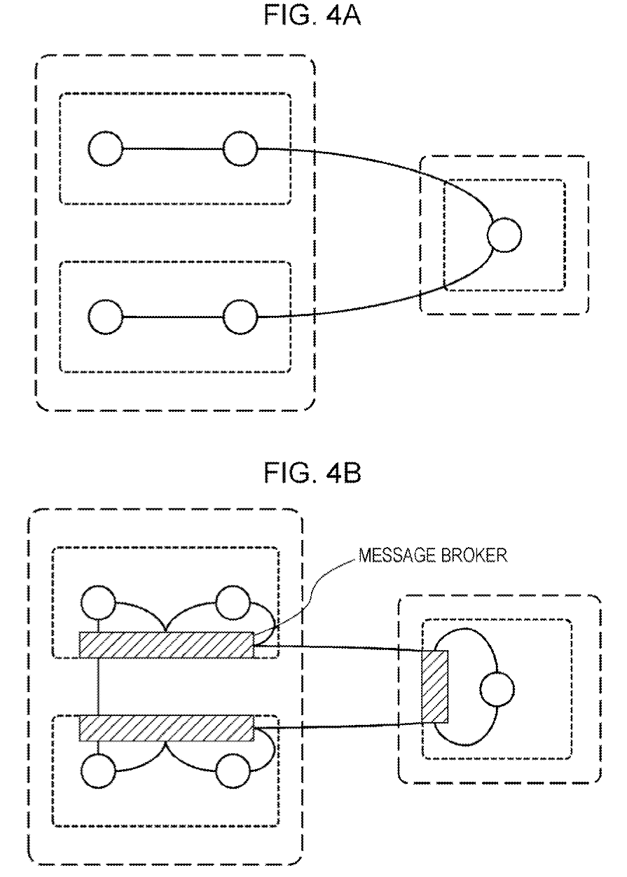

FIG. 4B shows a case where the message brokers are arranged in the respective processes of the distributed system having the module configuration shown in FIG. 4A. As shown in FIG. 4B, intermodule communication is performed in each of the processes and among the processes on the basis of the message passing through the message brokers.

### B-2-2. Serialization and Deserialization of Message Broker

The serialization corresponds to processing for writing a variable (field) representing a state of an object and an identifier representing a type (class) of an object in a form of a byte sequence or in an XML format suitable for a file form. On the contrary, in the deserialization, the serialized data is restored. Since the message passing performed in a process corresponds to memory-sharing parallel processing, serialization and deserialization of the message data may be omitted.

As described above, all the messages are subjected to the message passing through the message brokers. Each of the message brokers determines whether the serialization or the deserialization is to be performed in accordance with a determination as to whether message data is received from the same process or an external process or a determination as to whether message data is so be transmitted to the same process or an external process. Before the determination is performed, each of the message brokers should recognize she relationship between transmission and reception of the message data (that is, the relationship between a transmission module and a reception module).

Examples of a method for recognizing the relationship between transmission and reception include a method for embedding information on message-transmission source and information on transmission-destination module in a message and a method for obtaining the relationship between transmission and reception of a message by a message broker in advance when the system is activated. The present invention is not limited to a specific method, and therefore, a concrete description of a method for recognizing the relationship between transmission and reception is omitted.

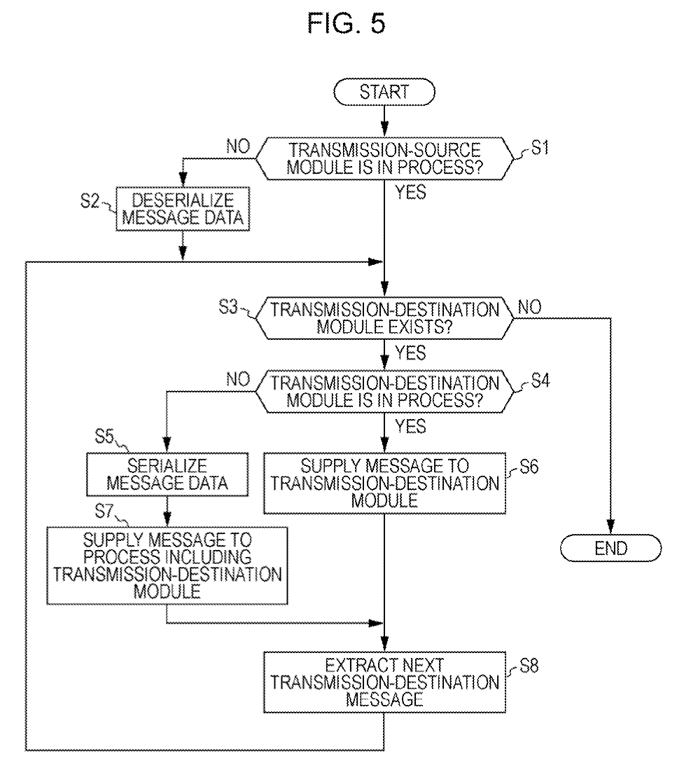

FIG. 5 is a flowchart illustrating a procedure of processing executed by a message broker when a message is supplied.

In step S1, when a message broker of interest, receives a message, a transmission source determines whether a module is included in a process corresponding to the message broker. When the determination is negative in step S1, message data corresponding to the message has been serialized by another message broker in a process including a transmission-source module. Therefore, the message broker of interest performs deserialization on the message data in step S2.

In step S3, the message broker of interest determines whether a transmission destination of the received message exists. When the determination is negative in step S3, that is, when the message passing for all specified transmission destinations has been terminated, the processing routine is terminated.

On the other hand, when the determination is affirmative in step S3, the process proceeds to step S4 where the message broker determines whether the transmission-destination module is included in the process corresponding to the message broker of interest.

When the determination is negative in step S4, the process proceeds to step S5 where the message broker performs serialization on the message data, and thereafter proceeds to step 37 where the message broker transmits the message data to a process including the transmission-destination module.

When the determination is affirmative in step S4, the process proceeds to step S6 where the message broker omits the deserialization to be performed on the message data, and supplies the message data to the transmission-destination module,

When the transmission of the message data is terminated in this way, the message broker extracts the next transmission-destination message in step S8, and the process returns to step S3 so that the operations described above are performed again.

B-3. High-Speed Message Passing by Message Reception without Message Queue

The modules include respective message queues each of which temporarily stores a message transmitted from another module. In the distributed system according to this embodiment, as another method for attaining high-speed message passing, a message is received without a message queue.

That is, when the message passing is performed, a determination is made as to whether the message queue is to be used. When the message queue is not used, a message issued by a transmission-source module is immediately processed by a transmission-destination module. In a case where the transmission-source module and the transmission-destination module are included in an identical process, if the message queue is not used, the message passing is enabled with a processing load the same as that of a function call. Accordingly, parallel processing of messages is performed among the modules included in the identical process.

### B-3-1. Message Passing Using Message Queue

First, message passing utilizing a message queue will be described. A message received by a transmission-destination module is temporarily stored in a message queue. Since the message is temporarily stored in the message queue, execution of a transmission-source module and execution of a transmission-destination module are separately performed whereby asynchronous distributed processing is realized.

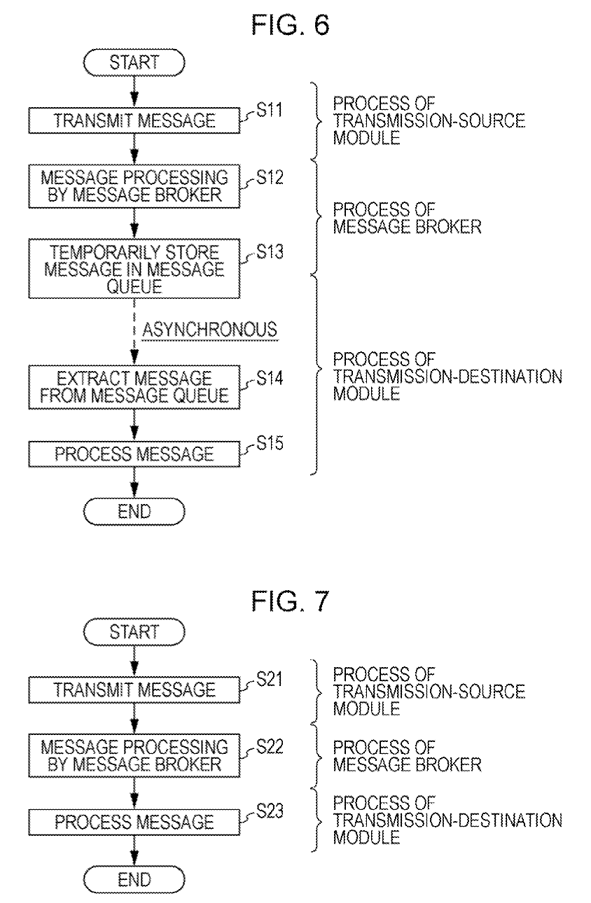

FIG. 6 is a flowchart illustrating a procedure of processing of the message passing when, the message queue is used.

In step S11, the transmission-source module transmits a message.

A message broker processes the transmitted message in step S12. For example, a message broker arranged in a process including the transmission-source module performs serialization on message data representing the message, and a message broker arranged in a process including the transmission-destination module performs deserialization on the message data (as described above). In step S13, the message broker arranged in the process including the transmission-destination module temporarily stores the message data in a message queue included in the transmission-destination module.

The processing of the transmission-destination module and the processing of the transmission-source module are performed as asynchronous distributed processing. Specifically, the transmission-destination module extracts a message stored in the message queue at a certain timing in step S14, and executes processing corresponding to the message in step S15.

B-3-2. Message Passing without Message Queue

Next, message passing performed without using a message queue will foe described. A message received by a transmission-destination module is immediately processed. This message passing method is performed when a transmission-source module and the transmission-destination module are included in an identical process.

FIG. 7 is a flowchart illustrating a procedure of processing of the message passing when the message queue is not used.

The transmission-source module transmits a message in step S21.

In step S22, a message broker performs processing on the transmitted message. In step S23, the transmission-destination module immediately executes processing corresponding to a message.

In a case where the transmission-source module and the transmission-destination module are included in an identical process, if a message queue is not used, asynchronous distributed processing is not performed (since execution of the transmission-source module and execution of transmission-destination module are not separately performed). However, the message passing is performed with a processing load the same as that of a function call.

### B-4. Solution of Process-Order Dependency in Synchronous Multicast

When interruption occurs, synchronous multicast transmission may be performed from a certain module to a plurality of other modules in a single process. In this case, process-order dependency among the modules should be taken into consideration.

For example, it is assumed that control of angles of joints of a hand and control for gripping an object using a hand are implemented as individual control modules, i.e., a joint-angle control module and an object-gripping control module. In this case, when a joint-angle instruction is first issued in response to an interruption which occurred in the joint-angle control module, a joint-angle instruction issued for the object-gripping control is not reflected in this control cycle.

In order to address such a problem of the process-order dependency among the modules in parallel processing, various methods may be used, such as, a method using the message passing, a method using a signal, and a method using a synchronous barrier, depending on the situation. However, these methods are merely solutions for a case where the modules are asynchronously executed, and do not satisfy a requirement of synchronous real-time processing.

As described above, in the distributed system according to this embodiment, the message passing which does not use a message queue may be performed, and the message passing is performed among the modules included in an identical process as synchronous communication. Such a message-passing method is not applicable to a general solution method suitable for asynchronous parallel processing.

Hereinafter, a method for addressing the problem of the process-order dependency in the synchronous multicast transmission to which the general solution method is not allowed to be applied will be described.

### B-4-1. Solution of Problem of Process-Order Dependency

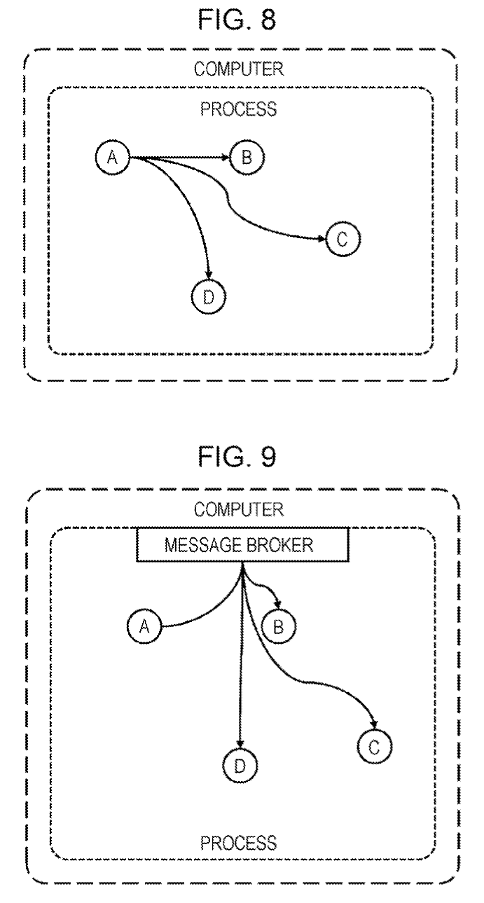

FIG. 8 is a diagram illustrating a state in which the synchronous multicast transmission is performed on a plurality of modules in a certain process of the distributed system.

In FIG. 8, a module A transmits messages to modules B, C, and D. The order in which the messages are received by the modules B to D is uncertain.

In the distributed system according to this embodiment, processes have respective message brokers, and intermodule communication in a single process or among processes is performed using the message passing through the message brokers (as described above). A state in which the synchronous multicast transmission is performed in a certain process using a message broker is shown in FIG. 9. When the message broker stores the process-dependency relationship among the modules B to D, the order in which messages are to be transmitted is sorted in accordance with the process-dependency relationship. In this way, the problem of the process-order dependency is addressed.

### B-4-2. Automatic Solution of Process-Order Relationship Based on Message Transmission/Reception

Before performing message transmission on the basis of the process-order relationship, the message brokers should check the process-order relationship among the modules and register a result of the checking therein.

In the distributed system according to this embodiment, the intermodule communication is performed using the message passing. In other words, the relationship among the modules is determined by the message passing.

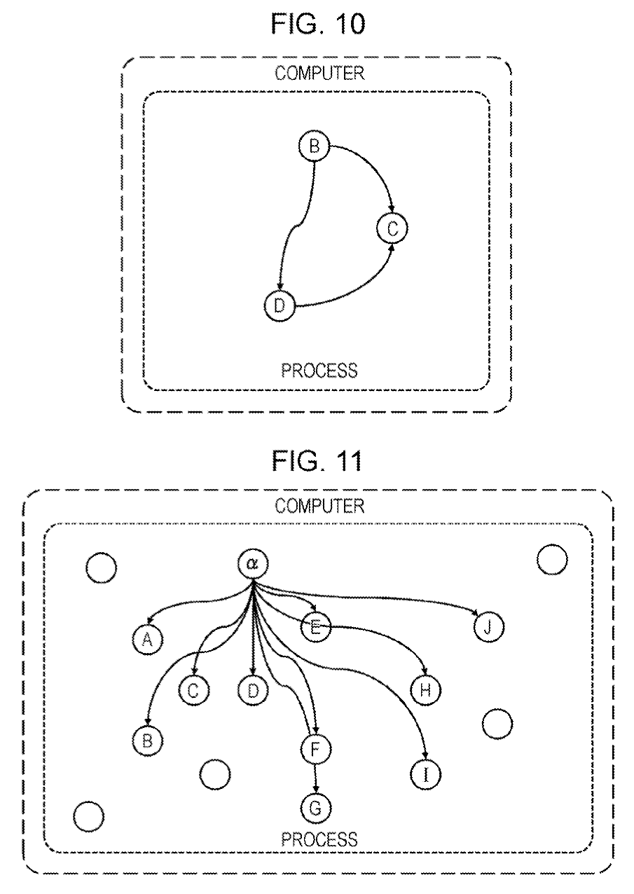

For example, when the module B transmits a message to the module C, the module C performs processing in accordance with information on the module B. Therefore, the module C depends on the module 8. In an example shown in FIG. 10, the module C depends on the modules B and D, and the module D depends on the module B.

Referring back to the example shown in FIG. 8, when the module A performs the synchronous multicast transmission to the modules B, C, and D, the transmission-destination modules are sorted so that messages are transmitted to the modules B, C, and D in this order. By this, the problem on the process-order dependency is addressed.

An example of an algorism for automatically deriving the process-order dependency relationships among modules in a certain process in accordance with the message transmission/reception relationships among the modules will be described hereinafter.

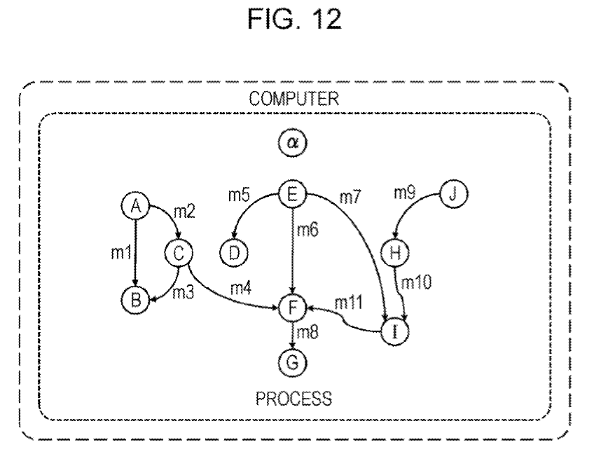

Here, a case where, in a certain process including a plurality of modules A to J as shown in FIG. 11, the synchronous multicast transmission from a transmission-source module α to the plurality of modules A to J is performed as indicated by arrow marks is taken as an example. In the process shown in FIG. 11, the transmission-destination modules A to J have the message transmission/reception relationships indicated by arrow marks as shown in FIG. 12. The modules which receive messages in the multicast transmission have the process-order dependency, and a problem caused by the process-order dependency should be addressed.

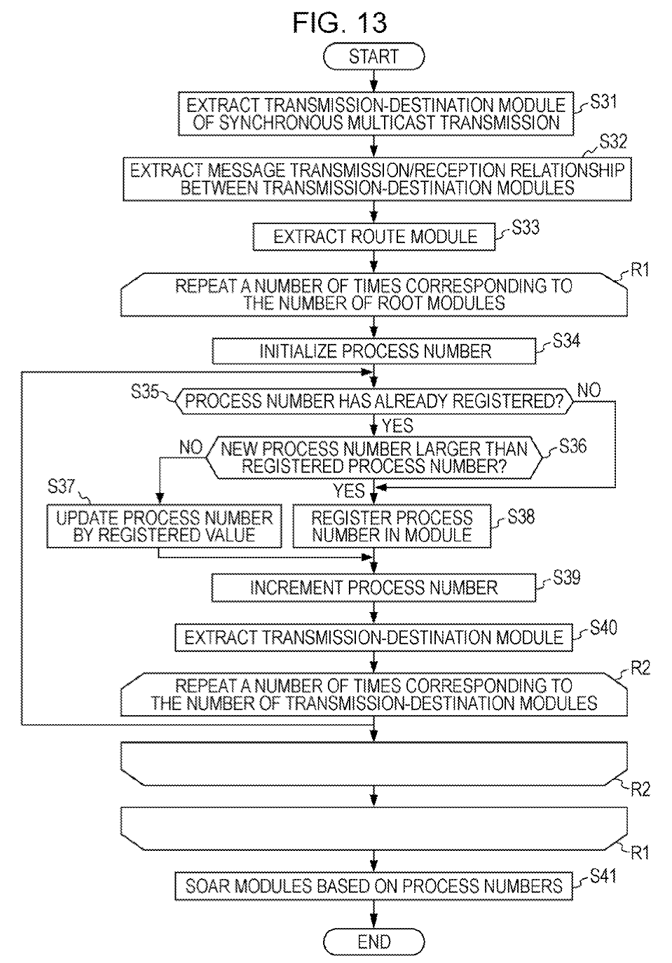

FIG. 13 is a flowchart illustrating a procedure of processing for automatically deriving the process-order dependency relationships among the modules in the certain process in accordance with the message transmission/reception relationships among the modules.

In the synchronous multicast transmission in the process, modules (transmission-destination modules) to receive messages are extracted in step S31. As shown in FIG. 11, when the synchronous multicast transmission is performed while the module a is set as a transmission-source module, the ten modules A to J are extracted, as the transmission-destination modules.

In step S32, message-passing components, i.e., the message transmission/reception relationships among the modules extracted as the transmission-destination modules of the synchronous multicast transmission are extracted. In the example of FIG. 12, 11 message-passing components indicating a direction from the module A to the module B, a direction from the module A to the module C, a direction from the module C to the module B, a direction from the module C to the module F, and so on, that is, message-passing components m1 to m11 are extracted among the ten transmission-destination modules A to J.

In step S33, among the transmission-destination modules in the synchronous multicast transmission, modules which do not receive messages from any other transmission-destination modules are extracted. Since such a module corresponds to a transmission source of the message passing in the message transmission/reception relationships extracted in step S32, such a module is referred to as a “root module”. In the example of FIG. 12, three modules, that is, the modules A, E, and J are extracted as root modules.

For each of the extracted root modules, modules connected to the root module of interest by the message passing are successively detected, and process numbers are assigned to the detected modules in ascending order. Specifically, a process number for the root module of interest is 1, and every time a module connected to the root module is detected, at process number incremented by one is assigned to the detected module. Note that if process numbers have been already assigned to some modules when message passing detection starring from another root module was performed before, larger process numbers are set as the process number thereof.

Referring to the flowchart of FIG. 13, in a loop R1 in which processing is repeatedly performed a number of times corresponding to the number of root modules, after the process number is initialized to one in step S34, it is determined whether a process number has been assigned to a module of interest in step S35. When the determination is affirmative in step S35, in step S36, it is determined whether a new process number is larger than the process number which has been assigned. When the determination is affirmative in step S36, the process proceeds to step S38 where the new process number is assigned to the module of interest whereas when the determination is negative, the process proceeds to step S37 where the process number which has been assigned is determined as the process number. On the other hand, when the determination is negative in step S35, the process proceeds to step S38 where the new process number is assigned. When assigning of the process number to the module of interest is completed, the process number is incremented by one in step S39. In step S40, the next transmission-source module connected in the memory passing is extracted. In a loop R2 which is repeatedly performed a number of times corresponding to the number of transmission-destination modules, such process-number assigning processing is repeatedly performed.

The description will be made with reference to the concrete example shown in FIG. 12 hereinafter. For example, when the root module A is set as a start module, the following operations are performed in the loop R1.

(1) A process number 1 is assigned to the root module A, and the process number is incremented by one. (2) A process number 2 is assigned to the modules B and C connected to the module A by the message passing, and the process number is incremented by one. (3) Although the process number 2 has been assigned to the module B connected to the module C by the message passing, the process number 2 of the module E is replaced by a process number 3 since the new process number 3 is larger than the process number 2. The process number 3 is also assigned to the module F connected to the module C by the message passing, and the process number is incremented by one. (4) A process number 4 is assigned to the module G connected to the module F by the message passing.

As a result of the operations (1) to (4), after the processing regarding the root module A is terminated, the process numbers have been assigned to the modules as shown in Table 1.

TABLE 1

| MODULE | PROCESS NUMBER |
|---|---|
| A | 1 |
| B | 3 |
| C | 2 |
| D | |
| E | |
| F | 3 |
| G | 4 |
| H | |
| I | |
| J | |

Similarly, after processing regarding the root module E is terminated, the process numbers have been assigned to the modules as shown in Table 2.

TABLE 2

| MODULE | RROCESS NUMBER |
|---|---|
| A | 1 |
| B | 3 |
| C | 2 |
| D | 2 |
| E | 1 |
| F | 3 |
| G | 4 |
| H | |
| I | 2 |
| J | |

Similarly, after the processing regarding the root module J is terminated, the process numbers have been assigned to the modules as shown in Table 3.

TABLE 3

| MODULE | PROCESS NUMBER |
|---|---|
| A | 1 |
| B | 3 |
| C | 2 |
| D | 2 |
| E | 1 |
| F | 4 |
| G | 5 |
| H | 2 |
| I | 3 |
| J | 1 |

The process numbers assigned to the transmission-destination modules as described above correspond to values representing the process-order dependency relationships in the synchronous multicast transmission. Then, in step S41, the transmission-destination modules are sorted in accordance with the process numbers.

In the example shown in FIG. 12, the transmission-destination modules A to J are sorted in an order from A, E, J, C, D, H, B, I, F, to G. When the synchronous multicast, transmission is performed from the module α, messages are transmitted in the order of sorting. Accordingly, the occurrence of the problem caused by the process-order dependency is prevented.

### C. Robot Control System Performing Synchronous Real-Time Processing and Asynchronous Parallel Processing

The motion control system of the robot according to this embodiment is implemented by the object-oriented technique (described above) and is configured by forming a tree-shaped hierarchy including a plurality of schemes. (The term “schema” corresponds to a module implemented by the object-oriented technique.) Such a distributed system should perform both synchronous real-time processing used for motion control and parallel processing used for the control which is other than motion control and which allows asynchronous processing.

In the distributed system described in the section B, the intermodule communication is performed using the message passing. The processes which are units of executions of programs in the computer have the respective message brokers. When the message passing is performed in one of the processes, a corresponding one of the message brokers omits serialization, deserialization, and a process for storing a message in a message queue. In this way, high-speed message passing is realized.

Accordingly, by implementing processes of a motion control system which should perform synchronous real-time processing as modules in an identical process, and implementing processes of control systems other than the motion control system as modules in different processes, parallelization of the processes is ensured. In this way, the distributed system which copes with conflicting requirements is configured.

Hereinafter, an operation procedure of the robot control system using the distributed system described above will be described in detail.

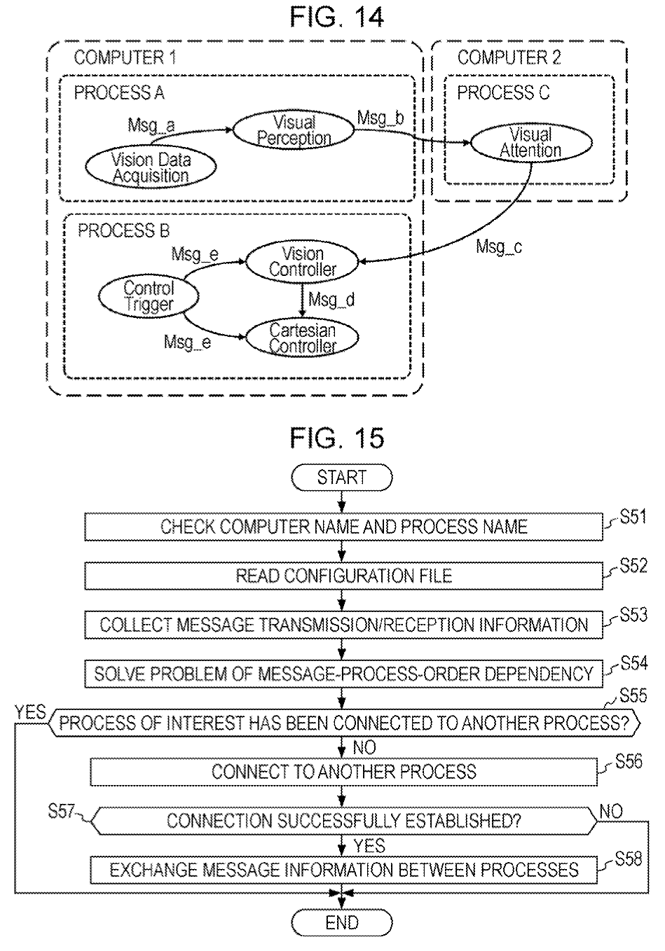

FIG. 14 is a diagram illustrating a subsystem relating to visual control in the motion control system of a robot. The visual-control subsystem shown in FIG. 14 is configured as a distributed system including modules to perform the synchronous real-time processing and modules to perform the asynchronous parallel processing in a mixed manner. The subsystem has a function for determining content to be noticed in accordance with information on visual sensors, such as the CCD cameras 15, and issuing a motion instruction for the visual control.

Furthermore, the visual-control subsystem shown in FIG. 14 includes two computers 1 and 2. In the visual-control subsystem, three processes A to C are executed in total, and six modules operate in total in the processes A to C. Note that, in FIG. 14, the term “computer” may be replaced by a term “processor”.

The computer 1 includes the processes A and B to be executed. The process A includes two modules, i.e., a module “Vision Data Acquisition” (visual-data input processing) and a module “Visual Perception” (visual perception processing). The process B includes three modules, i.e., a module “Control Trigger” (control trigger processing), a module “Vision controller” (sight-line control processing), and a module “Cartesian Controller” (position-and-posture control processing). The computer 2 includes the process C to be executed. The process C includes a module “Visual Attention” (visual attention processing). Roles of the modules are shown in Table 4. Note that a determination as to whether a received message is to be stored in a message queue is made in accordance with a message processing timing.

TABLE 4

| MODULE NAME | ROLE | MESSAGE PROCESS TIMING |
|---|---|---|
| Visual Data | PROCESSING FOR INPUTTING VISUAL DATA | INTERRUPTION BY SENSOR |
| Acquisition | FROM VISUAL SENSOR AND DEVICE | AND DEVICE |
| Visual | PROCESSING FOR RECOGNIZING OBJECT BY | ASYNCHRONOUS |
| Perception | VISUAL DATA ANALYSIS | |
| Visual | DETERMINATION OF VISUAL ATTENTION | ASYNCHRONOUS |
| Attention | DIRECTION BASED ON OBJECT PERCEPTION | |
| | RESULT | |
| Vision Controller | CONTROL OF LINE OF SIGHT | SYNCHRONOUS (REAL TIME) |
| Cartesian Controller | CONTROL OF POSITIONS AND POSTURES OF BODY | SYNCHRONOUS (REAL TIME) |
| | PORTIONS | |
| Control Trigger | ISSUANCE OF MESSAGE EVERY CONTROL CYCLE | |

A single process corresponds to a unit of execution of a program by a computer. When a group of modules to perform the synchronous real-time processing is included in a process, synchronous processing is realized. In the examples shown in FIG. 14 and Table 4, the modules of the motion control system, such as the module “Vision controller” and the module “Cartesian Controller”, are included in the process B and perform the synchronous real-time processing.

On the other hand, when different modules which allows the asynchronous processing and which should perform the parallel processing are included in different processes or different computers, the modules are executed in parallel. For example, a recognition module, such, as the module “Visual Perception”, and a thinking module, such as the module “Visual Attention”, are included in different processes and are processed in an asynchronous manner. Furthermore, since the two modules are distributed in the computers 1 and 2, respectively, parallel execution is ensured.

Furthermore, message brokers are included in the respective processes, and data transmission/reception among the modules is performed using the message passing through the message brokers. In the visual control subsystem shown in FIG. 14, a message Msg_a is transmitted from the module “Vision Data Acquisition” to the module “Visual Perception” in the process A. Moreover, a message Msg_b is transmitted from the module “Visual Perception” included in the process A to the module “Visual Attention” included in the process C. A message Msg_c is transmitted from the module “Visual Attention” included in the process C to the module “Vision controller” included in the process B. In the process B, a message Msg_e is transmitted from the module “Control Trigger” to the module “Vision controller” and the module “Cartesian Controller”, and a message Msg_d is transmitted from the module “Vision controller” to the module “Cartesian Controller”.

FIG. 15 is a flowchart illustrating a procedure of activation processing of the distributed system. The activation processing is performed in a unit of process. Accordingly, in the system configuration shown in FIG. 14, the activation processing is performed three times in total.

In step S51, a computer name and a process name are checked since a module to be executed is determined by the computer name and the process name.

In step S52, a system configuration file used to perform the activation processing is read. In accordance with the read system configuration file, modules of interest are instantiated and executed.

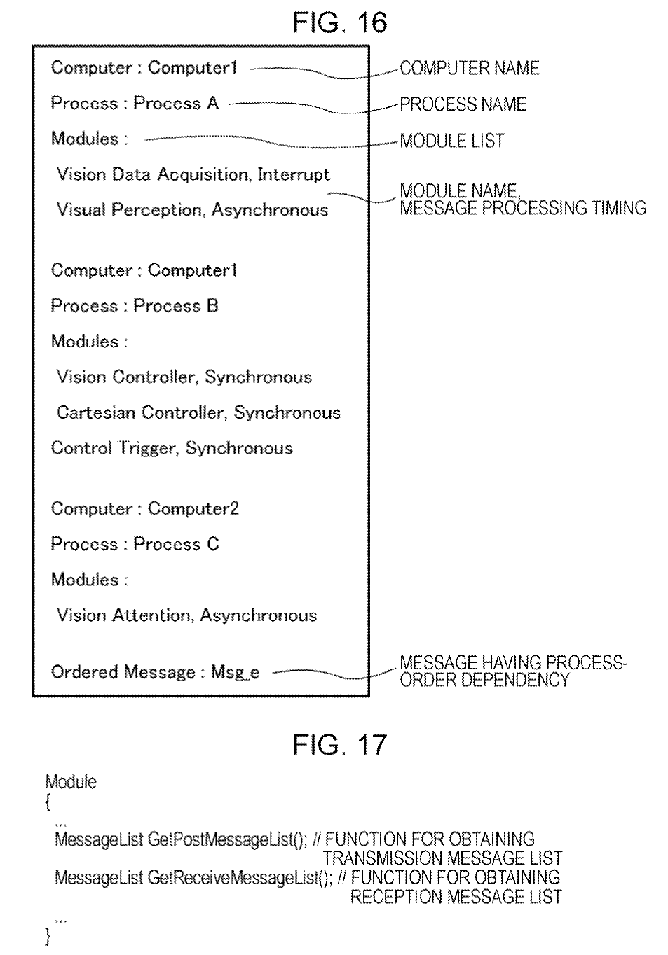

FIG. 16 is a diagram illustrating text description representing a configuration of the system configuration file corresponding to an example of a configuration of the distributed system shown in FIG. 14 and Table 4. As shown in FIG. 16, the system configuration file includes “computer name”, “process name”, “module list”, and “module name and message processing timing” in this order as configuration information for each process which is a unit of execution of a program. Note that “message processing timing” represents interruption of a process of interest. (Interrupt), synchronous (Synchronous), or asynchronous (Asynchronous). The system configuration file further includes “message having process-order dependency” (Ordered Message) which specifies a message having process-order dependency. For example, in step S51, a computer name “Computer 1” and a process name “Process A” are recognized, the module “Vision Data Acquisition” and the module “Visual Perception” are to be processed. Furthermore, since timings when messages received by the modules are to be processed are described in the system configuration file, the modules are instantiated in accordance with the timings.

In step S53, information on message transmission/reception among the modules to be instantiated is obtained.

In this embodiment, the modules included in the distributed system have respective units used to obtain the information on message transmission/reception. FIG. 17 is a diagram illustrating pseudo code of a module. In FIG. 17, a function “MessageList GetPostMessageList( )” for obtaining a transmission-message list and a function “MessageList GetReceiveMessageList( )” for obtaining a re caption-message list correspond to the pseudo code, and the information on message transmission/reception is obtained from the modules to be instantiated. Then, the obtained message transmission/reception information is used in “exchange of message information among processes” in the activation processing, and also used by the message brokers so that the message brokers appropriately use the messages.

In the distributed system shown in FIG. 14, in the processes A and B to be executed in the computer 1 and the process C to be executed in the computer 2, message transmission/reception information regarding transmission modules and reception modules for the messages as shown in Tables 5 to 7 is obtained. Rote that, as is apparent from Tables 5 to 7, message information among the processes is not obtained in the activation processing.

TABLE 5
PROCESS A EXECUTED IN COMPUTER 1

| MESSAGE | TRANSMISSION MODULE | RECEPTION MODULE |
|---|---|---|
| Msg_a | Vision Data Acquisition | Visual Perception |
| Msg_b | Visual Perception | |

TABLE 6
PROCESS B EXECUTED IN COMPUTER 1

| MESSAGE | TRANSMISSION MODULE | RECEPTION MODULE |
|---|---|---|
| Msg_c | | Vision Controller |
| Msg_d | Vision Controller | Cartesian Controller |
| Msg_e | Control Trigger | Vision Controller |
| | | Cartesian Controller |

TABLE 7
PROCESS C EXECUTED IN COMPUTER 2

| MESSAGE | TRANSMISSION MODULE | RECEPTION MODULE |
|---|---|---|
| Msg_b | | Visual Attention |
| Msg_c | Visual Attention | |

In step S54, a problem caused by the message process-order dependency in the synchronous multicast transmission is solved in accordance with the operations described above using the system configuration file read in step S52 and the message transmission/reception information obtained in step S53.

In a case of the distributed system shown in FIG. 14, since the message Msg_e is specified as the message having the process-order dependency in the system configuration file shown in FIG. 16, it is apparent that the message Msg_e is to be processed. Furthermore, from the message transmission/reception information shown in Table 6, it is apparent that the process B executed in the computer 1 is to be processed. Therefore, in accordance with the operations described above, the problem caused by the process-order dependency is solved.

In step S55, it is determined whether message transmission/reception information among the processes lacks the message transmission/reception information obtained in step S53. When the determination is negative in step S55, the process proceeds to step S56 where connection to another process is attempted so that information on lacking portion is covered.

In the examples shown in Tables 5 to 7, when the transmission module and the reception module are not included in an identical process, a column of the transmission module or the reception module remains blank. For example, in the activation processing for the process A to be executed in the computer 1, connection to the other process, i.e., the process B, executed in the computer 1 is attempted.

When it is determined that the connection to another process is successfully performed in step S57, the process proceeds to step S58 where message information is exchanged among the processes which lack the message transmission/reception information.

In the distributed system shown in FIG. 14, when all the processes are connected to one another, message transmission/reception information as shown in Tables 8 to 10 is obtained.

TABLE 8
PROCESS A EXECUTED IN COMPUTER 1

| MESSAGE | TRANSMISSION MODULE | RECEPTION MODULE |
|---|---|---|
| Msg_a | Vision Data Acquisition | Visual Perception |
| Msg_b | Visual Perception | Computer2, ProcessC, |
| | | Visual Attention |

TABLE 9
PROCESS B EXECUTED IN COMPUTER 1

| MESSAGE | TRANSMISSION MODULE | RECEPTION MODULE |
|---|---|---|
| Msg_c | Computer2, ProcessC, | Vision Controller |
| | Visual Attention | |
| Msg_d | Vision Controller | Cartesian Controller |
| Msg_e | Control Trigger | Vision Controller |
| | | Cartesian Controller |

TABLE 10
PROCESS C EXECUTED IN COMPUTER 2

| MESSAGE | TRANSMISSION MODULE | RECEPTION MODULE |
|---|---|---|
| Msg_b | Computer1, ProcessA, Visual | Visual Attention |
| | Perception | |
| Msg_c | Visual Attention | Computer1, ProcessB, |
| | | Visual Controller |

The message brokers attains high-speed message passing using the message transmission/reception information as described in the section B.

Next, some message in the distributed system shown in FIG. 14 are taken as examples, and a sequence of the message passing performed on the messages will be described.

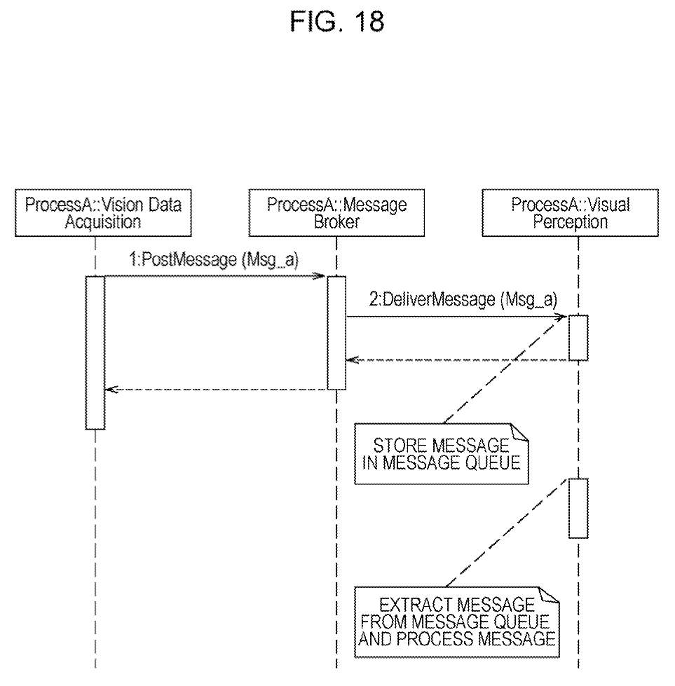

FIG. 18 is a diagram illustrating a sequence in which message passing of the message Msg_a shown in FIG. 14 is performed.

The message passing is performed from the module “Vision Data Acquisition” to the module “Visual Perception” through the message broker in the process A.

Since the transmission module and the reception module are included in the identical process, the message broker does not perform serialization and deserialization.

Furthermore, since the module “Visual Perception” serving as the reception module asynchronously processes messages as shown in Table 4, she message Msg_a is once stored in a message queue. Thereafter, the module “Visual Perception” extracts the message Msg_a from the message queue and processes the message Msg_a.

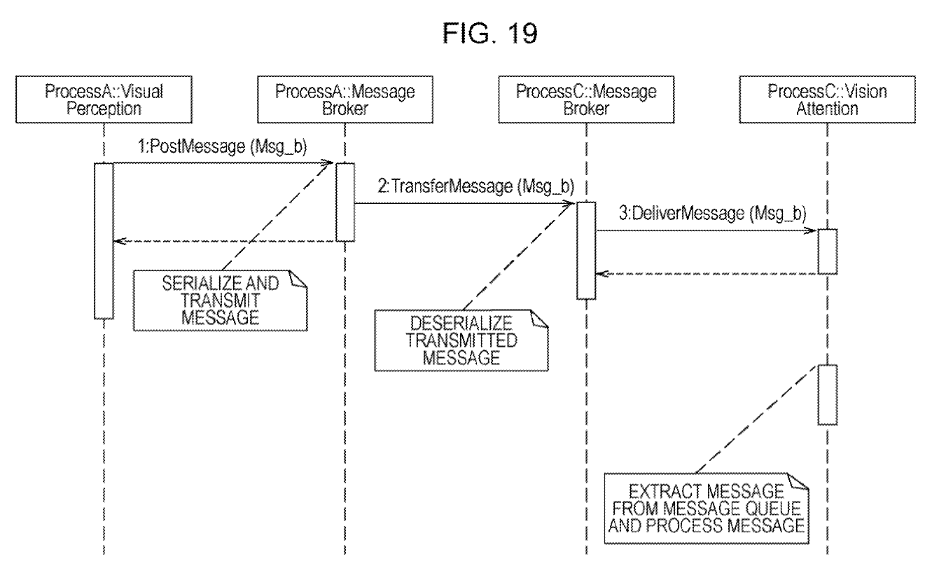

FIG. 19 is a diagram illustrating a sequence in which message passing of the message Msg_b shown in FIG. 14 is performed.

The message passing is performed from the module “Visual Perception” included in the process A to foe executed in the computer 1 to the module “Visual Attention” included in the process C to be executed in the computer 2 through the message brokers included in the processes A and C.

Since interprocess message passing is performed, the message broker on the transmission side transmits the message Msg_b to the process C after performing serialization on the message Msg_b transmitted from the transmission module “Visual Perception”. Then, the message broker on the reception side performs deserialization on the received message Msg_b before transmitting the message Msg_b to the reception module “Visual Attention”.

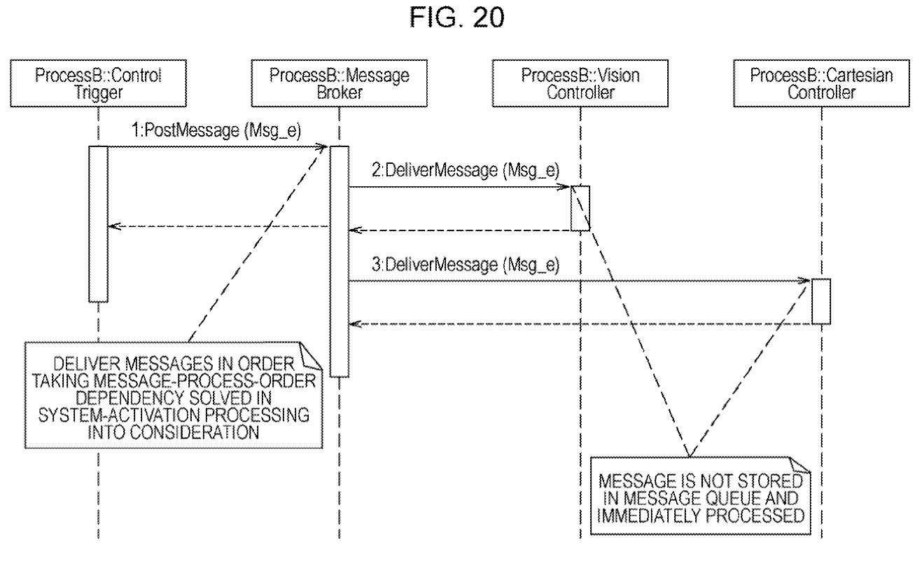

FIG. 20 is a diagram illustrating a sequence in which message passing of the messages Msg_e shown in FIG. 14 is performed.

The message passing is performed as the synchronous multicast transmission from the module “Control Trigger” to a plurality of modules, i.e., she module “Vision Controller” and the module “Cartesian Controller”, in a third process executed in the first computer through a message broker in the third process.

As shown in the system configuration file of FIG. 16, the messages Msg_e have the process-order dependency. Therefore, the message broker transmits the messages Msg_e to the modules in an order of sorting performed when the system is activated.

Since the module “Vision Controller” and the module “Cartesian Controller” which serve as the reception modules are set so as to perform the synchronous processing on messages as shown in Table 4, the messages Msg_e are not stored in message queues but immediately processed.

As is apparent from FIG. 20, in the message passing of the messages Msg_e, the messages Msg_e are synchronously processed by the reception modules and implemented only by a function call. Accordingly, the intermodule communication which satisfies a requirement of the real-time system is realized.

The present application contains subject matter related to that disclosed in Japanese Priority Patent Application JP 2008-182132 filed in the Japanese Patent Office on Jul. 14, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing system comprising:
synchronous processing means for executing a group of modules to perform synchronous real-time processing in a single process serving as a unit of execution of a program;
parallel processing means for arranging modules which allow asynchronous processing and which should perform parallel processing in different processes and executing the modules in parallel; and
intermodule communication means for performing transmission and reception of data among the modules by means of message passing.

2. The information processing system according to claim 1,
wherein the intermodule communication means is arranged for each process and includes a message broker used to exchange messages.

3. The information processing system according to claim 2,
wherein the message broker has a function of serialization in which a message is changed from an initial state to another state and deserialization in which the serialized message is deserialized, and when a message-transmission source and a message-reception source are included in an identical process, the serialization and the deserialization are omitted.

4. The information processing system according to claim 1,
wherein the modules include respective message queues each of which temporarily stores a message transmitted from the other module, and among the modules, when a transmission-source module and a transmission-destination module are not included in an identical process, the transmission-destination module temporarily stores a received message in the message queue whereas when the transmission-source module and the transmission-destination module are included in an identical process, the transmission-destination source omits the processing for storing the received message in the message queue.

5. The information processing system according to claim 1, further comprising;
process-order-dependency obtaining means for obtaining process-order dependency among the modules in a process; and
synchronous multicast transmission means for transmitting messages to transmission-destination modules in an order in accordance with the process-order dependency when synchronous multicast transmission is performed from a certain module included in a process to a plurality of modules.

6. The information processing system according to claim 5,
wherein the process-order-dependency obtaining means obtains the process-order dependency on the basis of the message transmission/reception relationships among the modules serving as the transmission-destination modules of the synchronous multicast transmission.

7. The information processing system according to claim 5,
wherein the process-order-dependency obtaining unit obtains, in the message transmission/reception relationships among the modules serving as transmission destinations in the synchronous multicast transmission, the process-order-dependency relationship in accordance with an order of connection of the modules starting from a root module only serving as a transmission source of the message passing.

8. The information processing system according to claim 5, further comprising:
means for collecting message transmission/reception information regarding transmission modules and reception modules of messages in accordance with a function for obtaining a list of transmission messages and a function for obtaining a list of reception messages included in each, of the modules; and
at configuration file which includes computer names which execute processes, module names included, in the processes, and message processing timings for the modules and which specifies a message having the process-order dependency,
wherein the process-order-dependency obtaining means obtains the process-order-dependency relationship using the configuration file and the message transmission/reception information.

9. The information processing system according to claim 8, further comprising:
message brokers which process messages using the function for obtaining the list of transmission messages and the function for obtaining the list of reception messages.

10. The information processing system according to claim 9,
wherein at least some of the modules include respective message queues which temporarily store messages transmitted from other modules, and
each of the message brokers determines whether a received message is to be stored in a message queue of a reception module in accordance with a message processing timing of the reception module described in she configuration file.

11. The information processing system according to claim 1,
wherein the information processing system includes two or more computers, and
among the modules which are to be asynchronously executed by the parallel processing means, especially modules to be executed in parallel are distributed in different processes to be executed in different computers.

12. An information processing method comprising the steps of:
executing synchronous processing a group of modules so perform synchronous real-time processing in a single process serving as a unit of execution of a program;
arranging modules which allow asynchronous processing and which should perform parallel processing in different processes and executing the modules in parallel; and
performing transmission and reception of data among the modules by means of message passing.

13. A system for controlling a robot which performs interaction with external environment through motions of joints, the system comprising:
synchronous processing means for executing a group of modules which to perform synchronous real-time processing and which are used for motion control in a single process serving as a unit of execution of a program;
parallel processing means for arranging modules which allow asynchronous processing, which should perform parallel processing, and which are used for control other than the motion control in different processes and executing the modules in parallel; and
intermodule communication means for performing transmission and reception of data among the modules by means of message passing.

14. A method for controlling a robot which performs interaction with external environment through motions of joints, the method comprising the steps of:
executing a group of modules which should perform synchronous real-time processing and which are used for motion control in a single process serving as a unit of execution of a program;
arranging modules which allow asynchronous processing, which should perform parallel processing, and which are used for control other than the motion control in different processes and executing the modules in parallel; and
performing transmission and reception of data among the modules by means of message passing.

15. A computer-readable program which includes a plurality of modules and which is to be executed in a computer, the computer program makes the computer function as:
synchronous processing means for executing a group of modules to perform synchronous real-time processing in a single process serving as a unit of execution of a program;
parallel processing means for arranging modules which allow asynchronous processing and which should perform parallel processing in different processes and executing the modules in parallel; and
intermodule communication means for performing transmission and reception of data among the modules by means of message passing.

16. A computer-readable program which includes a plurality of modules, which perform intermodule communication by means of message passing, and which is executed in a computer in a unit of process,
wherein a group of modules which should perform synchronous real-time processing is arranged in a single process, and modules which allow asynchronous processing and which should perform parallel processing are arranged in different processes,
message brokers are included in respective processes, each of the message broker being used for message exchanged between modules and which has a function of serialization in which a message is changed from an initial state to another state and deserialization in which the serialized message is deserialized, and when a message-transmission source and a message-reception source are included in an identical process, the serialization and the deserialization are omitted.

17. A computer-readable program which includes a plurality of modules, which perform intermodule communication by means of message passing, and which is executed in a computer in a unit of process,
wherein a group of modules to perform synchronous real-time processing is arranged in a single process, and modules which allow asynchronous processing and which should perform parallel processing are arranged in different processes, and
the modules include respective message queues each of which temporarily stores a message transmitted from the other module, and among the modules, when a transmission-source module and a transmission-destination module are not included in an identical process, the transmission-destination module temporarily stores a received message in the message queue whereas when the transmission-source module and the transmission-destination module are included in an identical process, the transmission-destination source omits the processing for storing the received message in the message queue.

18. A computer-readable program which includes a plurality of modules, which perform intermodule communication by means of message passing, and which is executed in a computer in a unit of process,
wherein a group of modules to perform synchronous real-time processing is arranged in a single process, and modules which allow asynchronous processing and which should perform, parallel processing are arranged in different processes, and
in at least some of the processes, an order of synchronous multicast transmission is determined in accordance with process-order relationships determined on the basis of the message transmission/reception relationships among modules serving as destinations of the synchronous multicast transmission.

19. An information processing system comprising:
a synchronous processing unit configured to execute a group of modules to perform synchronous real-time processing in a single process serving as a unit of execution of a program;
a parallel processing unit configured to arrange modules which allow asynchronous processing and which should perform parallel processing in different processes and execute the modules in parallel; and
an intermodule communication unit configured to perform transmission and reception of data among the modules by means of message passing.

20. A system for controlling a robot which performs interaction with external environment through motions of joints, the system comprising:
a synchronous processing unit configured to execute a group of modules which should perform synchronous real-time processing and which are used for motion control in a single process serving as a unit of execution of a program;
a parallel processing unit configured to arrange modules which allow asynchronous processing, which should perform parallel processing, and which are used for control other than the motion control in different processes and execute the modules in parallel; and
an intermodule communication unit configured, to perform transmission and reception of data among the modules by means of message passing.
